(19) United States
(12) Patent Application Publication
(10) Pub. No.: US 2012/0175508 A1
(43) Pub. Date: Jul. 12, 2012

(54) SENSOR MODULE

(75) Inventors: Masayoshi Kashima, Tokyo (JP); Nobuyuki Mano, Tokyo (JP)

(73) Assignee: SMK CORPORATION, Tokyo (JP)

(21) Appl. No.: 13/189,110

(22) Filed: Jul. 22, 2011

(30) Foreign Application Priority Data
Jan. 11, 2011 (JP) 2011-003429

(51) Int. Cl. H01J 40/14

(52) U.S. Cl. 250/239

(57) ABSTRACT

A sensor module includes a lens attached on an opening side of a housing and a circuit board with a sensor device mounted thereon attached on the other opening side. A stepped part is formed on the inside of the housing. An adjustment gap for adjusting the position of the circuit board is formed between a vertical face of this stepped part and an outer peripheral face of the circuit board. An adhesive injection groove that varies the width of the adjustment gap is formed by providing a recess and/or a projection on the vertical face of the stepped part and an opposing face of the outer peripheral face of the circuit board in at least one of at least two fixing portions where the circuit board is fixed to the stepped part with an adhesive. Adhesive is applied into the adhesive injection groove.

### CROSS-REFERENCE TO RELATED APPLICATIONS

This application claims priority to Japanese Patent Application No. JP 2011-003429, filed Jan. 11, 2011. The entire contents of this applications are hereby incorporated by reference herein.

### TECHNICAL FIELD

The present invention relates to a sensor module, which is a device in which light captured through a condenser lens is caused to form an image in an imaging device such as a charge-coupled device (CCD), for example, a cellular phone provided with a camera module, so arranged to allow secure attachment of a circuit board for the sensor module with the imaging device mounted thereon to a housing.

BACKGROUND ART

A known example of imaging systems of this type is a camera module 10 originally described in Japanese Unexamined Patent Publication No. 2003-169235 and depicted in FIG. 6. Explained specifically, a condenser lens 14 is attached on one of the opening sides of a square-cylinder or cylinder-shaped housing 11, while a circuit board 18 having a sensor device 16 such as an imaging device mounted thereon is attached on the other opening side. The condenser lens 14 is attached to a lens holder 12 via an aperture 13, and this lens holder 12 is screwed onto a housing 11 to attach a cover glass 15 to an opening end. A sensor device 16 is mounted on the circuit board 18 via a controlling element 17, and this circuit board 18 is fixed to a stepped part 21 at the other end of the opening of the housing 11 with an adhesive 20. Element 19 is a passive device. The circuit board 18 is fixed to the stepped part 21 formed on the other opening side of the housing 11 with the adhesive 20. In fixing the circuit board 18, it is freely fitted in an adjustment gap 22 between the inner surface of the stepped part 21 and the outer periphery of the circuit board 18, positioned so that the center of the sensor device 16 surely coincides with the optical axis of the condenser lens 14, and is then fixed with the adhesive 20.

In this fixing of the circuit board 18 with the adhesive 20, as shown in FIG. 8 (d), a projecting portion 25 is formed on the inside of the housing 11 and a positioning pin 23 is provided in a stepped part 21 of this projecting portion 25. Alternatively, as shown in FIG. 8 (e), a positioning pin 23 is directly provided in the stepped part 21 and a positioning hole of the circuit board 18 is fitted with this positioning pin 23. As shown in FIG. 7 (a), the adhesive 20 is applied to the adjustment gap 22 between the circuit board 18 and the entire periphery of the stepped part 21. As shown in FIG. 8 (b), the adhesive 20 is applied into the adjustment gap 22 between the circuit board 18 and three sides of the stepped part 21. In addition, the adhesive 20 has been conventionally applied in the following manner: as shown in FIG. 8 (a), applying into the adjustment gap 22 at the vertical face of the stepped part 21; as shown in FIG. 8 (b), forming a tapered portion 24 at a vertical portion of the stepped part 21 and applying the adhesive so that the adhesive 20 easily enters the adjustment gap 22; as shown in FIG. 8 (c), forming a two-step stepped part 21 at the vertical face of the stepped part 21, among other methods.

A method of fixing the diagonally positioned portions as shown in FIG. 5 with the adhesive 20 is also known and is described in Japanese Unexamined Patent Publication No. 2010-251843. This method involves: providing the stepped part 21 on the opening side on the back side of the housing 11; forming circular protrusions 31 at diagonally positioned corner portions in this stepped part 21; forming an arcuate notch portion 30 on a face opposing the protrusion 31 on the side of the circuit board 18 across a gap; and applying the adhesive 20 after the positioning of the circuit board 18 in a manner of infilling the space between the protrusions 31 and a notch portion 30 for fixing.

### SUMMARY OF THE INVENTION

### Problems to be Solved by the Invention

As shown in FIGS. 7 (a) and (b), providing the positioning pin 23 in the stepped part 21 and fitting the positioning pin 23 with the positioning hole of the circuit board 18 have had the problem that it not only requires extra steps for precisely forming the positioning pin 23 and the positioning hole since the camera module 10 is extremely small, but also adversely affects the adjustment of positions. In particular, as in FIG. 7 (a), which depicts the method of applying the adhesive 20 around the entire periphery of the circuit board 18, although the position of the circuit board 18 is not shifted when the adhesive 20 is cured, additional time is required for applying the adhesive 20 around the entire periphery of the circuit board 18.

FIG. 5 depicts a method including forming protrusions 31 in diagonally positioned corner portions in the stepped part 21 on the back side of the housing 11, forming notch portions 30 on a face opposing the protrusions 31 on the side of the circuit board 18, and applying the adhesive 20 in a manner of infilling the space between the protrusions 31 and the notch portions 30. In this method, as in the case of FIG. 7, it is necessary to form the protrusions 31 in the stepped part 21 and form the notch portions 30 in the circuit board 18, which complicates the structure. Furthermore, the stepped part 21 for forming the protrusions 31 extend inside of the circuit board, which increases the width of the stepped part 21 accordingly and decreases the area for mounting electronic parts. This limits the size reduction of the camera module 10 itself.

To this end, a method of fixing the circuit board 18 in at least two portions without a complicated constitution including components such as the positioning pin 23 and protrusions 31 would greatly improve the working process. However, when peeling of the adhesive 20 occurs on the stepped part 21 side or the circuit board 18 side by impact and vibration exerted thereon, the circuit board 18 and housing 11 which have been already aligned are disadvantageously misaligned. The present invention aims to provide a sensor module in which a circuit board for sensor module having a sensor device such as an imaging device mounted thereon is fixed to a housing with an adhesive applied only in at least two portions, regardless of the viscosity of the adhesive at the time of application, and even if peeling of the adhesive occurs by impact or vibration exerted thereon, and thus can be securely retained with no misalignment.

### Means for Solving the Problems

The sensor module according to the present invention is a sensor module in which a condenser lens is attached on one opening side of a cylindrical housing and a circuit board for sensor module with a sensor device mounted thereon is fixed on the other opening side of the housing with an adhesive. A stepped part is formed on the inside of the housing as a face for fixing the circuit board in the housing. An adjustment gap for adjusting the position of this circuit board is formed between a vertical face of this stepped part and an outer peripheral face of the circuit board. In at least one of at least two fixing portions where the circuit board is fixed to the stepped part with the adhesive, a recess and/or a projection is provided on a vertical face of the stepped part in the adjustment gap and near an opposing face of the outer peripheral face of the circuit board, to form an adhesive injection groove that varies the width of the adjustment gap. The circuit board is fixed by applying the adhesive into this adhesive injection groove.

In some embodiments, the adhesive is applied not only into the adhesive injection groove but also into a part of the adjustment gap which is continuous with the adhesive injection groove.

The adhesive injection groove can be characterized in that it is formed by providing recesses on the vertical face of the stepped part in the adjustment gap and near the opposing face of the outer peripheral face of the circuit board, respectively, so that the width of the same is larger than that of the adjustment gap.

The adhesive injection groove can be characterized in that it is formed by, in order to bend the adjustment gap, providing a recess either on the vertical face of the stepped part in the adjustment gap or near the opposing face of the outer peripheral face of the circuit board, and providing a protrusion on the other.

The adhesive injection groove can be characterized in that it is formed by, in order to bend the adjustment gap in a zigzag manner, providing a plurality of recesses and projections on each of the vertical face of the stepped part in the adjustment gap and the opposing face of the outer peripheral face of the circuit board.

### Effects of the Invention

According to the invention as defined in claim 1, in a sensor module in which a condenser lens is attached on one opening side of a cylindrical housing, and a circuit board for sensor module with a sensor device mounted thereon is fixed on the other opening side of the housing with an adhesive, a stepped part is formed on the inside of the housing as a face for fixing the circuit board in the housing. An adjustment gap for adjusting the position of this circuit board is formed between a vertical face of this stepped part and an outer peripheral face of the circuit board. An adhesive injection groove, which varies the width of the adjustment gap, is formed by providing a recess and/or a projection on a vertical face of the stepped part in the adjustment gap and near an opposing face of the outer peripheral face of the circuit board in at least one of at least two fixing portions where the circuit board is fixed to the stepped part with an adhesive. An adhesive is applied into this adhesive injection groove for fixing. Therefore, the adhesive in the portion in which the adhesive injection groove is formed attains such a state that a wedge is inserted when the adhesive is cured. Accordingly, even if peeling of the adhesive on the housing side and on the circuit board side occurs by impact and vibration exerted thereon, the positional relationship between the housing and the circuit board can be securely retained to an appropriate state. In addition, the adhesive can be applied in a limited number of portions (e.g., two, three, four, and the like), and thus working efficiency can be greatly improved.

Moreover, by applying the adhesive into a portion of the adhesive injection groove that varies the width of the adjustment gap, when the viscosity of the adhesive is rather low at the time of application, an appropriate amount of adhesive is applied where the width of the groove is small, while when the viscosity of the adhesive is rather high, an appropriate amount of adhesive is applied where the width of the groove is large. Therefore, a secure fixing state can be obtained regardless of the viscosity of the adhesive.

According to the invention as defined in claim 2, the adhesive is applied into the adhesive injection groove and a portion of the adjustment gap that is continuous with this adhesive injection groove for fixing. Therefore, peeling is unlikely to occur since the adhesive is injected into the adjustment gap with a varying width and the adhesive injection groove, and even if peeling occurs, the position of the circuit board is not shifted and the circuit board can be securely retained.

According to the invention as defined in claim 3, the adhesive injection groove is formed by providing recesses on the vertical face of the stepped part in the adjustment gap and near the opposing face of the outer peripheral face of the circuit board, respectively, so that the width of the same is larger than that of the adjustment gap, and therefore an adhesive with high viscosity can be successfully injected thereinto.

According to the invention as defined in claim 4, the adhesive injection groove is formed by, in order to bend the adjustment gap, providing a recess either on the vertical face of the stepped part in the adjustment gap or near the opposing face of the outer peripheral face of the circuit board, and providing a protrusion on the other, and therefore the adhesion area of the adhesive after being cured can be increased.

According to the invention as defined in claim 5, the adhesive injection groove is formed by, in order to bend the adjustment gap in a zigzag manner, providing a plurality of recesses and projections on each of the vertical face of the stepped part in the adjustment gap and the opposing face of the outer peripheral face of the circuit board. Therefore, the adhesion area of the adhesive after being cured can be increased, and the circuit board can be securely attached.

### BRIEF DESCRIPTION OF THE DRAWINGS

FIG. 1 (a) is a bottom plan view showing one of examples of the sensor module according to the present invention, while FIG. 1 (b) is an expanded cross-sectional view taken along line A-A in FIG. 1 (a).

FIGS. 2 (a), (b), (c), (d), (e) and (f) are bottom plan views that show different examples of an adhesive injection groove 26 formed in an adjustment gap 22 between a stepped part 21 of a housing 11 and the outer peripheral face of a circuit board 18, respectively, and where an adhesive 20 is injected into an adhesive injection groove 26 and further into a part of an adjustment gap 22 that is continuous with this adhesive injection groove 26.

FIG. 3 (a) is a cross-sectional view that shows an example where one end of the housings 11 is an end face 27 with no vertical wall, while FIGS. 3 (b), (c) and (d) are bottom plan views that show different examples where the adhesive 20 is injected only into the adhesive injection groove 26.

FIG. 4 is a cut-away cross-sectional view that shows an example where two circuit boards 18 and 29 connected by a flat cable 28 is incorporated in the housing 11, and at least the circuit board 18 side is fixed to the stepped part 21 of the housing 11 according to Examples in FIGS. 1 to 4.

FIG. 5 is a bottom plan view that shows a conventional example of fixing the circuit board 18 by applying the adhesive 20 in diagonally-positioned corner portions.

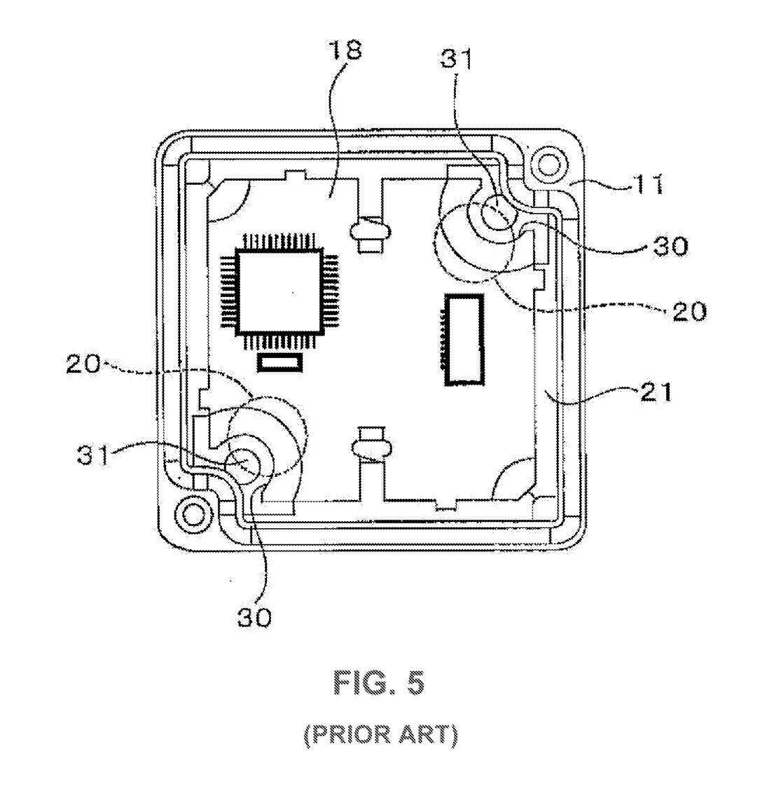

FIG. 6 is a cut-away cross-sectional view that shows a camera module as a conventional imaging system.

FIGS. 7 (a) and (b) are bottom plan views that show different examples of conventional fixing.

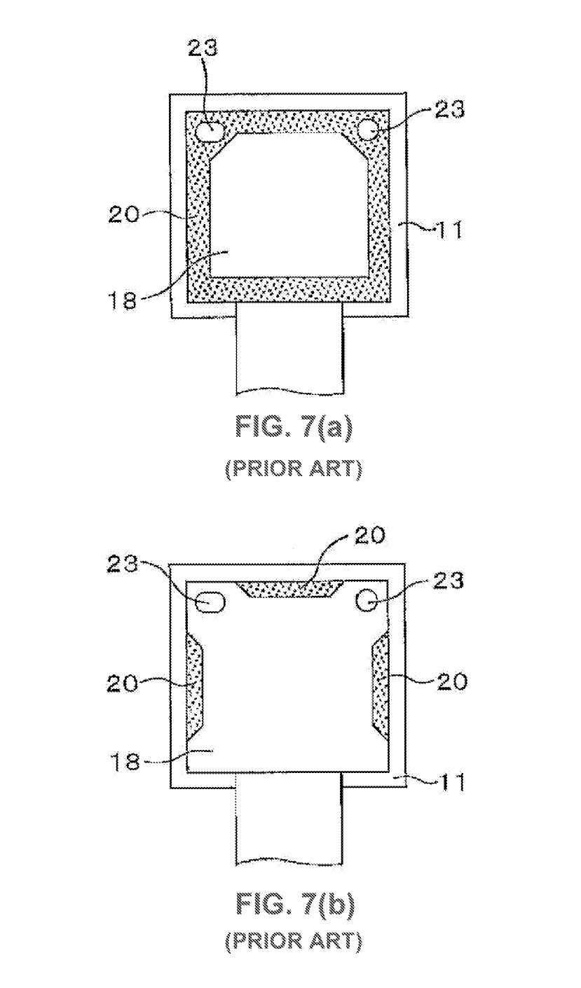

FIGS. 8 (a), (b), (c), (d) and (e) are bottom plan views that show different examples of fixing the outer peripheral face of the circuit board 18 to the stepped part 21 of the housing 11 with the adhesive 20.

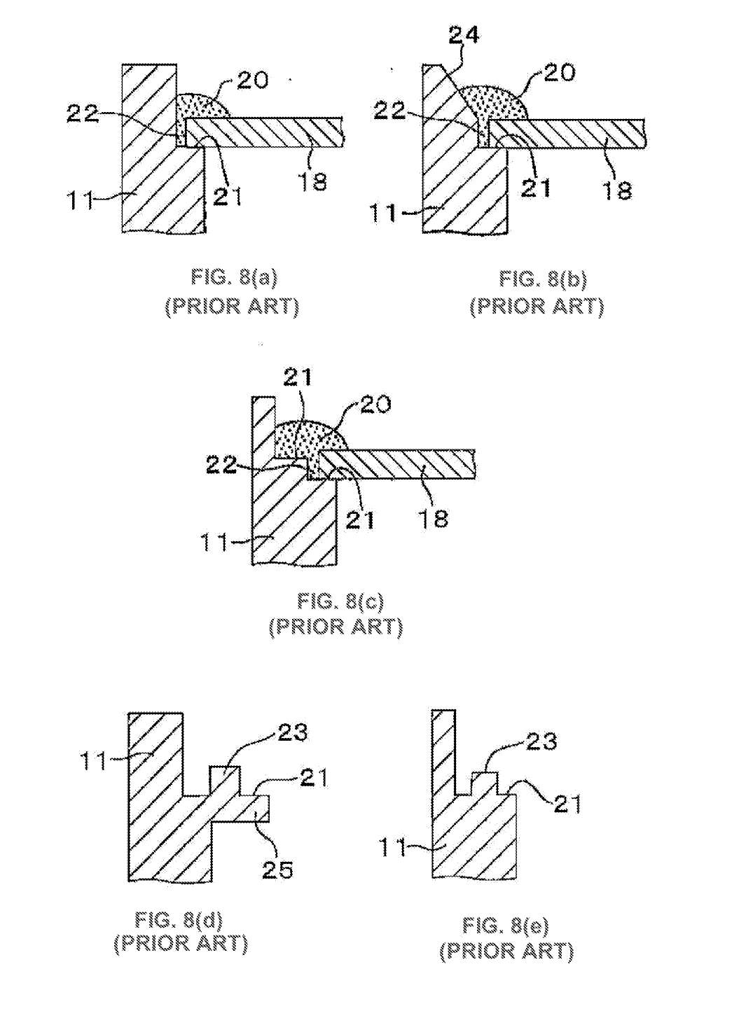

### MODE FOR CARRYING OUT THE INVENTION

In the present invention, in a sensor module so arranged that a condenser lens is attached on one opening side of a cylindrical housing, and a circuit board for sensor module with a sensor device mounted thereon is fixed on the other opening side of the housing with an adhesive, a stepped part is formed on the inside of the housing as a face for fixing the circuit board in the housing. An adjustment gap for adjusting the position of this circuit board is formed between a vertical face of this stepped part and an outer peripheral face of the circuit board. An adhesive injection groove, which varies the width of the adjustment gap, is formed by providing a recess and/or a projection on a vertical face of the stepped part in the adjustment gap and near an opposing face of the outer peripheral face of the circuit board in at least one of the at least two fixing portions where the circuit board is fixed to the stepped part with an adhesive. An adhesive is applied into this adhesive injection groove.

In order to successfully and easily inject the adhesive into the adjustment gap and adhesive injection groove, a stepped part is formed within a housing as a face for fixing the circuit board in the housing, an adjustment gap for adjusting the position of this circuit board is formed between the vertical face of this stepped part and the outer peripheral face of the circuit board, and an adhesive injection groove is formed on the vertical face of the stepped part opposing this adjustment gap and an opposing face of the outer peripheral face of the circuit board.

The adhesive can be applied not only into the adhesive injection groove, but also into a part of the adjustment gap which is continuous with this adhesive injection groove for fixing.

The adhesive injection groove can be formed by providing recesses on the vertical face of the stepped part in the adjustment gap and near the opposing face of the outer peripheral face of the circuit board so that the width of the same is larger than that of the adjustment gap.

In addition, in order to bend the adjustment gap, the adhesive injection groove can be formed by providing a recess either on the vertical face of the stepped part in the adjustment gap or near the opposing face of the outer peripheral face of the circuit board and providing a protrusion on the other.

In addition, in order to bend the adjustment gap in a zigzag manner, the adhesive injection groove can be formed by providing a plurality of recesses and projections on each of the vertical face of the stepped part in the adjustment gap and the opposing face of the outer peripheral face of the circuit board.

### First Example

A first example of the present invention will be described below with reference to the drawings.

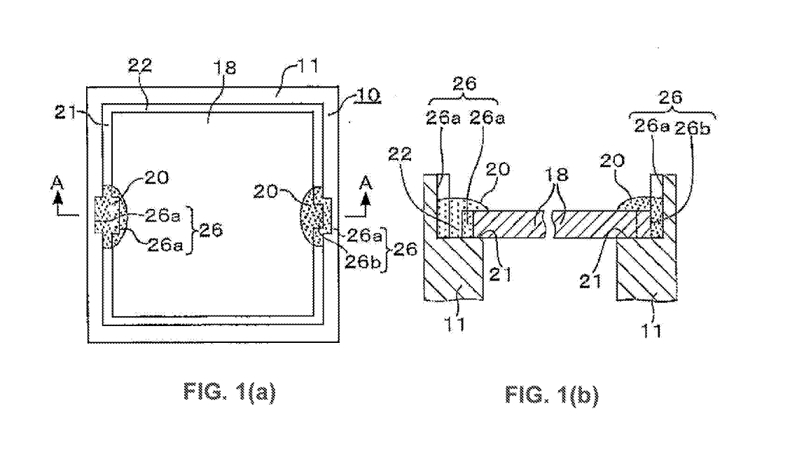

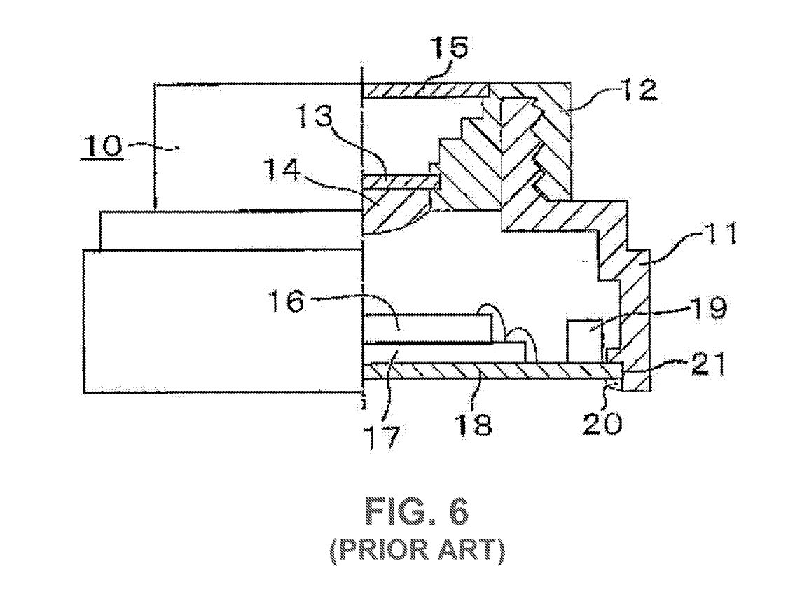

FIG. 1 (a) shows a bottom plan view of the sensor module according to the present invention, while FIG. 1 (b) shows a cross-sectional view of the sensor module taken along line A-A. The inner structure of a camera module 10 is approximately the same as in the conventional example depicted in FIG. 6 and like parts in the conventional example are referred to by like numerals in the drawings.

In FIG. 1, a housing 11 of the camera module 10 is in the form of a square cylinder, and a stepped part 21 is formed around the entire inner periphery of an end of the opening on its bottom face. A circuit board 18 is fitted with the stepped part 21. An adjustment gap 22 for adjusting the position of the circuit board 18 is formed between the outer peripheral face of this circuit board 18 and the vertical face of the stepped part 21 of the housing 11. An adhesive 20 is applied to at least two portions in this adjustment gap 22 so that the circuit board 18 is fixed to the housing 11.

When the portions of the stepped part 21 where the adhesive 20 is applied are linearly positioned, a recess 26a and/or a projection 26b is formed on both the outer peripheral face of the circuit board 18 and in the vertical face of the stepped part 21 of the housing 11 in at least one portion thereof to construct an adhesive injection groove 26 that varies the width of the adjustment gap 22.

More specifically, in FIGS. 1 (a) and (b), the left halves of the drawings each show an example where a square-shaped recess 26a are formed on the outer peripheral face of the circuit board 18. A square-shaped recess 26a is also formed on the opposing vertical face of the stepped part 21 of the housing 11. An adhesive injection groove 26 that varies the width of the adjustment gap 22 by recesses 26a, 26b is constructed. The adhesive 20 is applied into this adhesive injection groove 26 and a portion of the adjustment gap 22 that is continuous with this adhesive injection groove 26.

In addition, the right halves of FIGS. 1 (a) and (b) each show an example where the square-shaped recess 26a is formed on the vertical face of the stepped part 21 of the housing 11. A square-shaped projection 26b is formed on the opposing outer peripheral face of the circuit board 18. The adhesive injection groove 26 that varies the width of the adjustment gap 22 is constructed by these recess 26a and projection 26b. The adhesive 20 is applied into this adhesive injection groove 26 and a portion of the adjustment gap 22 that is continuous with this adhesive injection groove 26.

When the adhesive 20 is injected for fixing in such a manner, even if peeling of the adhesive 20 occurs at both or either of the housing 11 and the circuit board 18, the cured adhesive 20 serves as a wedge by the presence of the adhesive injection groove 26, and the shift in the position of the circuit board 18 with respect to the housing 11 can be securely prevented. In the example of FIG. 1, the two adhesive injection grooves 26 are formed in the left and right portions, respectively, but in the case where the adhesive 20 is filled into at least two portions, the adhesive injection groove 26 may be formed only in either of the portions. In addition, the number of the portions into which the adhesive 20 is filled may be three or more, and the adhesive injection groove 26 may be formed in at least one of the portions.

The adhesive 20 used can, for example, be an ultraviolet-curable adhesive 20 that has a low viscosity when uncured and cures when irradiated with an ultraviolet ray in a short period of time (about 10 seconds). However, the adhesive 20 is not limited to such an example.

### Further Examples

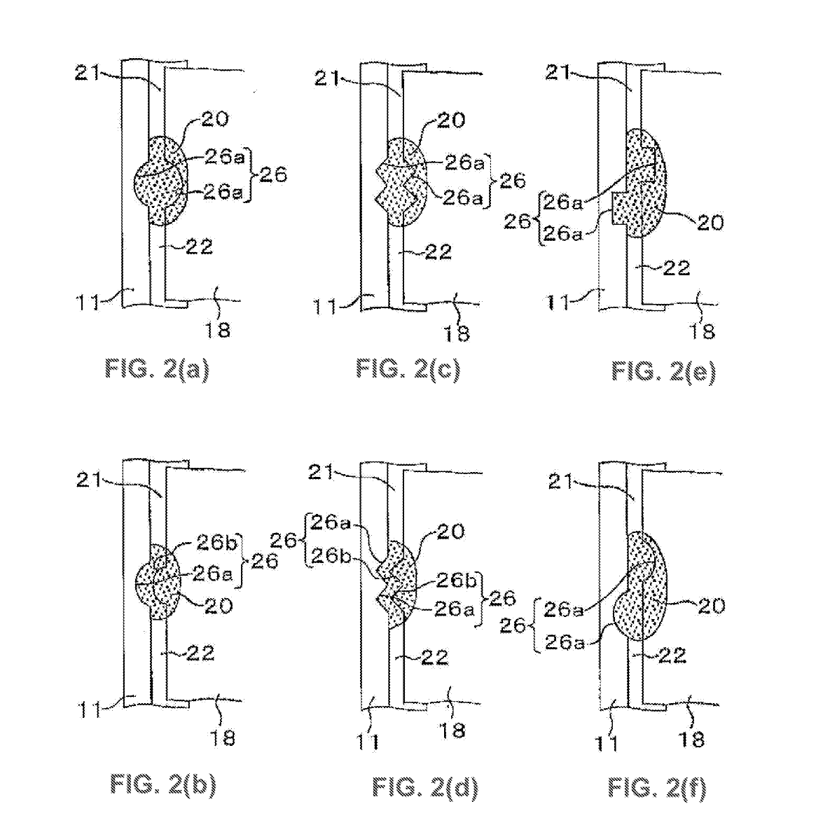

FIG. 2 depicts further examples of adhesive injection grooves 26. FIG. 2 (a) depicts an example in which a semicircular recess 26a is formed on the vertical face of the stepped part 21 of the housing 11 and a semicircular recess 26a is formed on the opposing outer peripheral face of the circuit board 18. An adhesive injection groove 26 that varies the width of the adjustment gap 22 is constructed by these recesses 26a. The adhesive 20 is applied into this adhesive injection groove 26 and a portion of the adjustment gap 22 that is continuous with this adhesive injection groove 26.

FIG. 2 (b) depicts an example where a semicircular recess 26a is formed on the vertical face of the stepped part 21 of the housing 11 and a semicircular projection 26b is formed on the opposing outer peripheral face of the circuit board 18. An adhesive injection groove 26 that varies the width of the adjustment gap 22 is constructed by these recess 26a and projection 26b. The adhesive 20 is applied into this adhesive injection groove 26 and a portion of the adjustment gap 22 that is continuous with this adhesive injection groove 26.

FIG. 2 (c) depicts an example where recesses 26a, 26a and projections 26b, 26b are formed in a manner of facing each other on each of the outer peripheral face of the circuit board 18 and the vertical face of the stepped part 21 of the housing 11 to construct a saw-tooth-shaped adhesive injection groove 26. The adhesive 20 is applied into this adhesive injection groove 26 and a portion of the adjustment gap 22 that is continuous with this adhesive injection groove 26.

FIG. 2 (d) depicts an example in which a recess 26a and a projection 26b and a projection 26b and a recess 26a are formed on the outer peripheral face of the circuit board 18 and the vertical face of the stepped part 21 of the housing 11, respectively, in a manner of facing each other to form a zigzag-shaped adhesive injection groove 26. The adhesive 20 is applied into this adhesive injection groove 26 and a portion of the adjustment gap 22 that is continuous with this adhesive injection groove 26.

FIG. 2 (e) depicts an example in which a square-shaped recess 26a is formed on the vertical face of the stepped part 21 of the housing 11 and a square-shaped recess 26a is formed on the outer peripheral face of the opposing circuit board 18 in a position slightly shifted from the position of the recess 26a of the housing 11 to construct the adhesive injection groove 26. The adhesive 20 is applied into this adhesive injection groove 26 and a portion of the adjustment gap 22 that is continuous with this adhesive injection groove 26.

FIG. 2 (f) depicts an example in which semicircular recess 26a is formed on the vertical face of the stepped part 21 of the housing 11 and a semicircular recess 26a is formed on the opposing outer peripheral face of the circuit board 18 in a position slightly shifted from the position of a recess 26a of the housing 11 to construct the adhesive injection groove 26. The adhesive 20 is applied into this adhesive injection groove 26 and a portion of the adjustment gap 22 that is continuous with this adhesive injection groove 26.

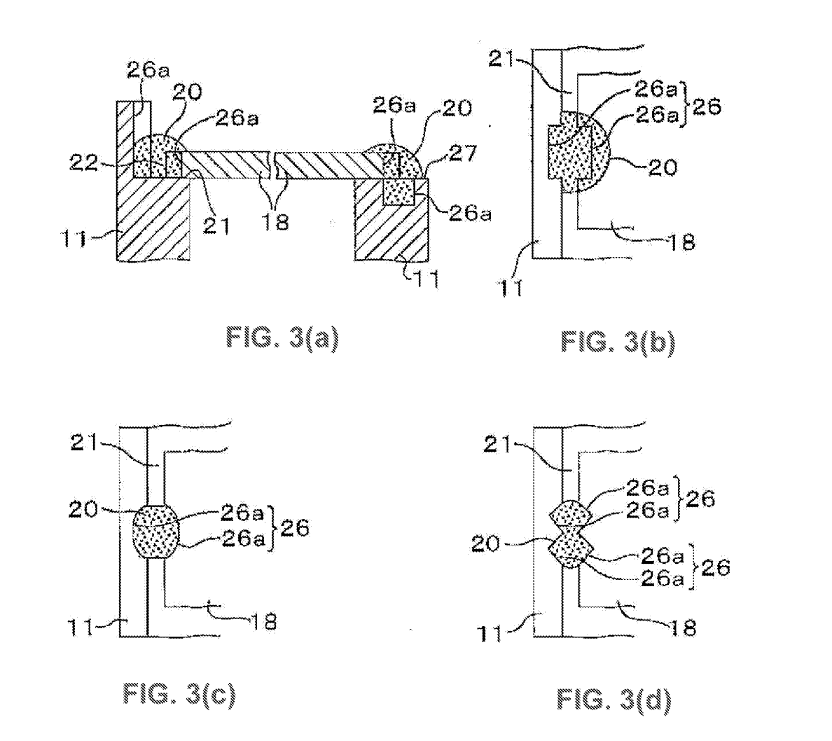

FIG. 3 (a) shows an example in which an adhesive injection groove 26 is formed on each of the outer peripheral faces of the circuit board 18 and the vertical face of the stepped part 21 of the housing 11 to receive the adhesive 20 thereinto in one of the fixing portions. On the other hand, the housing 11 does not have a vertical face in the other fixing portion. An adhesive injection groove 26 is formed on an end face 27 of the housing 11 and the adhesive 20 is filled into in a portion including this adhesive injection groove 26.

FIGS. 3 (b), (c) and (d) depict examples where the adhesive 20 is injected only into the adhesive injection groove 26 and the adhesive 20 is not filled into a part of an adjustment gap 22 that is continuous with this adhesive injection groove 26.

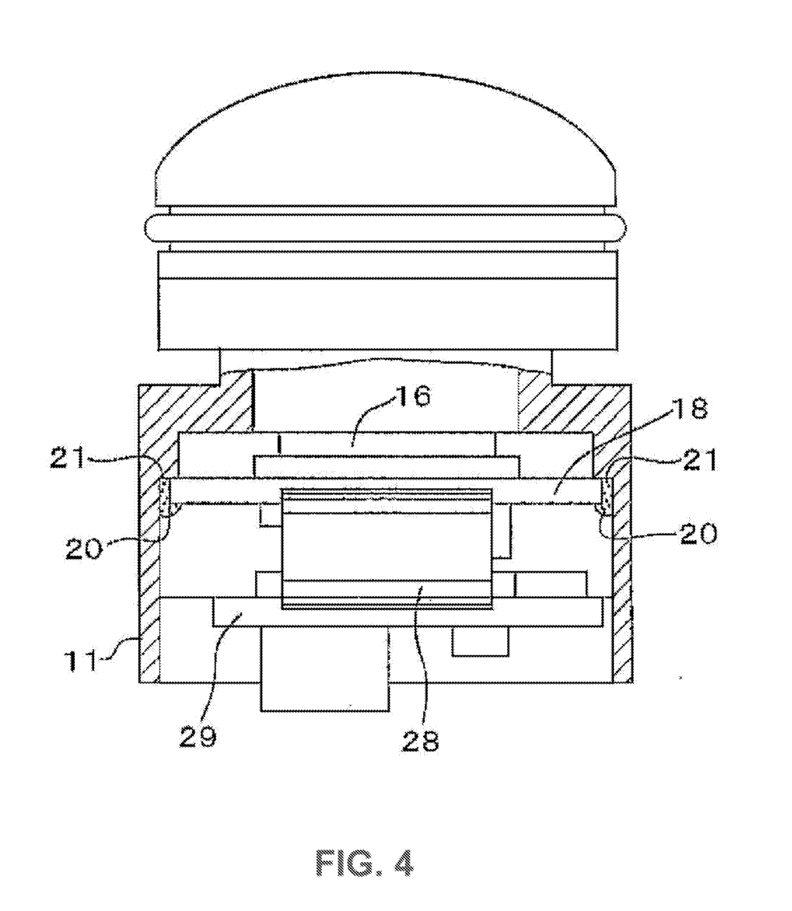

FIG. 4 shows an example in which two circuit boards 18 and 29 connected by a flat cable 28 are incorporated into the housing 11, where at least the circuit board 18 side is fixed to the stepped part 21 of the housing 11 according to the examples depicted in FIGS. 1 to 3.

The shapes of the adhesive injection groove 26, recess 26a, and projection 26b are not limited to those in Examples above, and may be such that the adhesive 20 in at least one of the at least two (left and right) fixing portions serves as a wedge.

### EXPLANATION OF REFERENCES

10 . . . Camera module
11 . . . Housing
12 . . . Lens holder
13 . . . Aperture
14 . . . Condenser lens
15 . . . Cover glass
16 . . . Sensor device
17 . . . Controlling element
18 . . . Circuit board
19 . . . Passive device
20 . . . Adhesive
21 . . . Stepped part
22 . . . Adjustment gap
23 . . . Positioning pin
24 . . . Tapered portion
25 . . . Projecting portion
26 . . . Adhesive injection groove
26a . . . Recess
26b . . . Projection
27 . . . End face
28 . . . Flat cable
29 . . . Circuit board
30 . . . Notch portion
31 . . . Protrusion

### INCORPORATION BY REFERENCE

All patents, published patent applications, and other references disclosed herein are hereby expressly incorporated by reference in their entireties by reference.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

1. A sensor module comprising:
a condenser lens is attached on a first opening side of a cylindrical housing, and
a circuit board with a sensor device mounted thereon fixed on a second other opening side of the housing with an adhesive,
wherein:
a stepped part is formed on the inside of the housing as a face for fixing the circuit board in the housing,
an adjustment gap for adjusting the position of the circuit board is formed between a vertical face of the stepped part and an outer peripheral face of the circuit board,
an adhesive injection groove, which varies the width of the adjustment gap, is formed by providing a recess and/or a projection on a vertical face of the stepped part in the adjustment gap and near an opposing face of the outer peripheral face of the circuit board in at least one of at least two fixing portions where the circuit board is fixed to the stepped part with the adhesive, and
the circuit board is fixed by applying the adhesive into the adhesive injection groove.

2. The sensor module according to claim 1, wherein the adhesive is applied into the adhesive injection groove and a part of an adjustment gap that is continuous with this adhesive injection groove for fixing.

3. The sensor module according to claim 1, wherein the adhesive injection groove is formed by providing recesses on the vertical face of the stepped part in the adjustment gap and near an opposing face of the outer peripheral face of the circuit board, respectively, so that the width of the same is larger than that of the adjustment gap.

4. The sensor module according to claim 1, wherein the adhesive injection groove is formed by, in order to bend the adjustment gap, providing a recess either on the vertical face of the stepped part in the adjustment gap or near the opposing face of the outer peripheral face of the circuit board, and providing a protrusion on the other.

5. The sensor module according to claim 1, wherein the adhesive injection groove is formed by, in order to bend the adjustment gap in a zigzag manner, providing a plurality of recesses and projections on each of the vertical face of the stepped part in the adjustment gap and the opposing face of the outer peripheral face of the circuit board.
